(19) United States
(12) Patent Application Publication
(10) Pub. No.: US 2010/0125827 A1
(43) Pub. Date: May 20, 2010

(54) DEVELOPING SOFTWARE CODE USING PARAMETERIZED ANNOTATIONS

(75) Inventors: Timothy Marc Francis, Newmarket (CA); David Martin Slubicki, Raleigh, NC (US); Jianjun Zhang, Cary, NC (US)

Correspondence Address: IBM Corporation-Raleigh SWG;c/o Thomas, Raring & Teague, P.C, 536 Granite Avenue, Richmond, VA, 23226, US

(73) Assignee: International Business Machines Corporation, Armonk, NY (US)

(21) Appl. No.: 12/272,982

(22) Filed: Nov. 18, 2008

(51) Int. Cl. G06F 9/44

(52) U.S. Cl. 717/109; 717/106

(57) ABSTRACT

The present invention provides the ability to use annotations to represent current user configuration concerning a particular “domain model,” which allows for round-trip support as well as choosing the specific implementation technology at a later point. The present invention provides a preview capability which allows users to dynamically expand the annotation to preview what will be generated based on the current configuration information. The present invention generates software code based on the user configuration input and packages the generated software code for deployment without allowing a user to edit the generated software code.

### BACKGROUND

The present invention relates to developing software code.

Software development and debugging is typically performed using an integrated development environment (IDE). An IDE typically comprises a source code editor, a compiler and/or interpreter, build automation tools, and a debugger. Code development tools, such as IDEs, often perform code generation based on user input. For example, if a user wants to consume a web service from a Java servlet class, a typical development tool will prompt a user for input via a wizard-like user interface (UI). The user is prompted to provide configuration details that will enable the tool to generate the desired code. The tool with then generate the necessary Java code into the servlet, as well as Java classes to support the web service proxy call (stub types, etc.).

While this type of development tool is useful, there are problems with this approach. One such problem is the potential loss of “round-trip support.” Round-trip support refers to the ability of the software development tool to recognize and handle changes made to the generated code by a user (this ability to go backward from the generated code to the wizard is termed reverse-engineering) such that the user-changed code can still be supported and further configured by the tool. For example, consider an IDE that has a JDBC (Java DataBase Connectivity) data access wizard which allows users to specify a target database table and generates Java code to access the data thru an SDO (Service Data Object)-based mediator runtime. The wizard solicits the following input from the user (for illustration purposes, this is a simplified list): connection name; SDO data object name; target database table; and query parameter names and values (or expressions). Using this user input, the IDE will generate Java code to access the desired data.

In a typical IDE, the generated code will be available to the user before the code is deployed, such that the user will be able to make changes to the generated code. If the user makes particular changes to the generated code (such as by changing certain statements inside a method body), then the next time the wizard is launched in order to do further configuration it becomes impossible to reverse-engineer the original configuration model based on the generated code. Therefore, round-trip support is broken. Whether round-trip support breaks because of user changes to the generated code typically depends on the type of changes made by the user. Typically, syntax changes do not break round-trip support, but semantics changes do break round-trip support.

Another problem with this type of development tool is that the generated code is technology-specific (i.e., conforms to a particular software standard, protocol, or language). This can be seen in the example above, in which the wizard was specific to the SDO mediator-based data access technology. If the user later on decides to use, for example, EJB (Enterprise JavaBean)-based access, the user will have to delete the generated code and start over with an EJB creation wizard. This would require the user to re-enter much or all of the same configuration information.

### BRIEF SUMMARY

The present invention provides the ability to use annotations to represent current user configuration, which allows for round-trip support as well as choosing the specific implementation technology at a later point. The present invention provides a preview capability which allows users to dynamically expand the annotation to preview what will be generated based on the current configuration information. The present invention generates software code based on the user configuration input and packages the generated software code for deployment without allowing a user to edit the generated software code.

In one embodiment of the invention, a method of developing software code comprises soliciting and receiving user input regarding one or more software configuration properties, storing the user input, generating software code based on the user input, and packaging the generated software code for deployment without allowing a user to edit the generated software code. The user input may be stored as one or more annotations.

The method may further comprise, prior to generating the software code, creating and displaying a preview of the software code to be generated. Additionally, the method may further comprise soliciting and receiving user selection of a software technology. In such an embodiment, the generated software code is compliant with the selected software technology.

In addition to the method of developing software code, as described above, other aspects of the present invention are directed to corresponding systems and computer program products for developing software code.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a flowchart of the operation of a method of developing software code, in accordance with one embodiment of the present invention;

FIG. 2 is a schematic block diagram of a computer network in which embodiments of the present invention may operate; and

FIG. 3 is a schematic block diagram of a computer in the network of FIG. 2.

### DETAILED DESCRIPTION

The present invention provides a method, system and computer program product for developing software code in which configuration information is received from a user, saved, and used to generate software code. The configuration information defines particular aspects of the desired software code. For example, the configuration information may define a connection name (i.e., the name of a connection to an external data source), a data object name (i.e., the name of an object in memory that contains data that is desired to be accessed), a target database table (i.e., which database table contains data that is desired to be accessed), query parameter names and values (i.e., the criteria for selecting the rows in the database table that are desired to be accessed), relationship to other database tables (i.e., additional selection criteria and/or additional information stored in other database tables), database schema (i.e., which particular set of tables to access), etc. The present invention provides a preview capability which allows users to dynamically expand the annotation to preview what will be generated based on the current configuration information. The present invention generates software code based on the user configuration input and packages the generated software code for deployment without allowing a user to edit the generated software code.

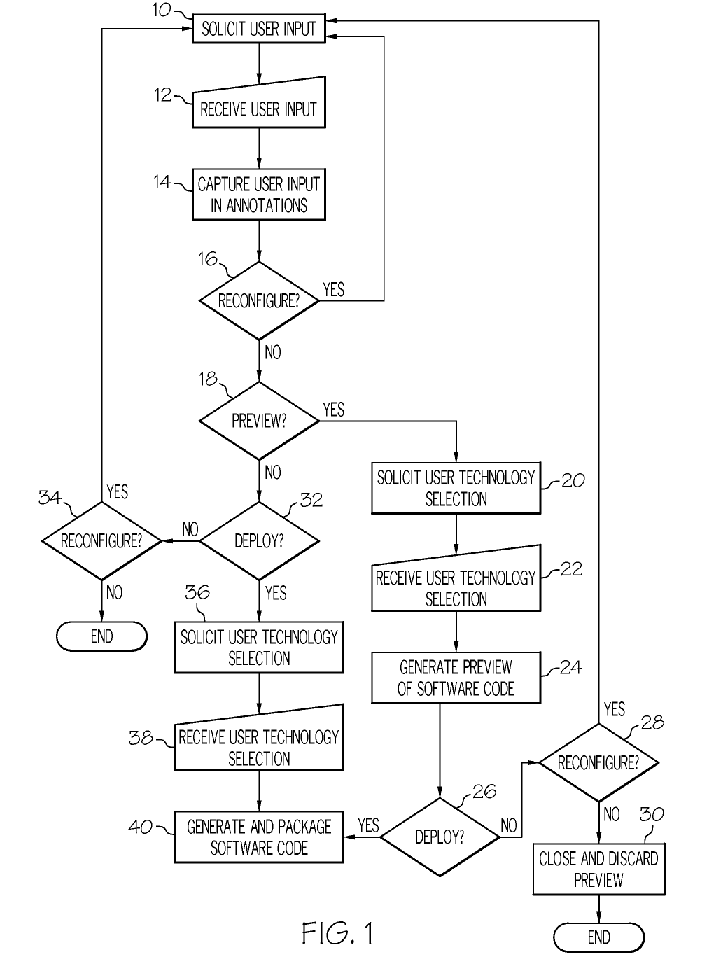

Embodiments of the invention may be implemented in an IDE. Referring now to FIG. 1, a flowchart of the operation of a method of developing software code is illustrated in accordance with one embodiment of the present invention. User input regarding the desired software code configuration is solicited (block 10) and received (block 12) from a user. The user input is captured and stored (block 14). In one embodiment, the user input is saved as annotations. Storing the input as annotations is typically desirable when developing Java code. In other embodiments and for developing other types of code, the user input may be saved as, for example, macros or special elements.

The annotation mechanism will allow parameters to capture the user input choices, as well as allowing further updates. Because all the information is captured in a well-defined, much condensed format, it is very easy to re-construct the current model from the code (i.e., reverse-engineer). The “annotation with parameters” format also makes it very easy to provide code assistance. For instance, when the “connection_name” is at focus, the code assistance can inspect the workspace and provide the list of defined connections to choose from.

After initially inputting configuration information, the user may be given the opportunity to reconfigure the input by changing some information and/or adding information (block 16). The user may be given the choice of viewing a preview of the code to be generated (block 18). When “preview” is requested, the user will typically be prompted for a “technology” (i.e. software standard, protocol, or language) choice (block 20). The user will typically be presented with a list of technologies appropriate for implementing the intended solution. For example, in the above example in which a database access application is being developed, the user may be presented with the following technology options: SDO-mediator, EJB, and JPA (Java Persistence API (Application Program Interface)). After a selection is received from the user (block 22), the invention will proceed with an “internal” generation operation in order to generate and display a preview (block 24). However, no actual resources or code will be generated for this preview operation. After viewing the preview, the user can decide whether to deploy the previewed code (block 26). If the user selects not to deploy the code, the user can choose either to reconfigure the code (block 28) or to simply close and discard the preview (block 30).

If the user selects to deploy the code after viewing the preview, the invention will generate the desired software code based on the user input captured in the annotations, and package the generated code for deployment (block 40). Packaging the generated code for deployment typically comprises putting the code and associated resources into a well understood format that is appropriate to the technology selected by the user. If necessary, packaging may also comprise compiling source code into machine or binary code. After packaging, the software code is deployed to a specified target environment (the deploy process will not be described in detail as the deploy process (after packaging of the code) is known). The code is packaged for deployment without allowing a user to edit the generated software code. This prevents the user from directly editing the generated code, which in turn ensures that the IDE will be able to reverse-engineer the code.

If the user does not choose to preview in block 18, the user can decide whether to deploy the code (block 32). If the user selects not to deploy the code, the user can choose to reconfigure the code (block 34). If the user selects to deploy the code, the user will typically be prompted for a “technology” (i.e. software standard, protocol, or language) choice (block 36). As above, the user will typically be presented with a list of technologies appropriate for implementing the intended solution. After a selection is received from the user (block 38), the invention will generate the desired software code based on the user input captured in the annotations and package the generated code for deployment (block 40). As above, the software code is deployed after packaging to a desired target environment, and is packaged without allowing a user to edit the generated software code.

In one example, a user may desire to generate software code that retrieves records from a database named “SAMPLE.” An IDE that encompasses embodiments of the invention would prompt the user to input configuration information needed to generate the code, such as database connection name, target database table, selected columns, row selection criteria. In this simplified example, the user input is captured and saved as the below two annotations:

@JDBCConnection (name=″SAMPLE″,
class=″ConnectionWrapper″)
@JDBCTarget (var=″frequentFlyerInfo″, query=”select * from

DBMADMIN.FrequentFlyer where EMPNO = ?”,
parameterValues={“#″param.EMPNO}″}).

Using just the above two annotations, all the essential application settings for this particular problem domain has been captured. There would be one annotation processor and code generator per technology choice per problem domain, so in this example the annotation processor and code generator corresponding to the “JDBC Mediator” technology will be able to generate and package (or create a preview of) the following Java runtime code:

private static final String SDOConnection_name = “SAMPLE”;
private ConnectionWrapper SDOConnectionWrapper;
protectedDataObject frequentFlyerInfoParameters;
protected JDBCMediator frequentFlyerInfoMediator;
private static final String frequentFlyerInfo_metadataFileName = “/WEB-

INF/wdo/frequentFlyerInfo.xml”;

protected static final String[ ] frequentFlyerInfoArgNames = { “paramEMPNO” };
protected static final String[ ] frequentFlyerInfoArgValues = { “#{param.EMPNO}” };
protected List frequentFlyerInfo;
protected ConnectionWrapper getSDOConnectionWrapper( ) {

if(SDOConnectionWrapper == null) {

try {

Connection con = ConnectionManager

.createJDBCConnection(SDOConnection_name);

SDOConnectionWrapper = ConnectionWrapperFactory.soleInstance

.createConnectionWrapper(con);

} catch (Throwable e) {

logException(e);

}

}
return SDOConnectionWrapper;

}
/**
* @action id=frequentFlyerInfo
*/
public String doFrequentFlyerInfoUpdateAction( ) {

try {

getFrequentFlyerInfoMediator( ).applyChanges(

getRootDataObject(getFrequentFlyerInfo( )));

} catch (Throwable e) {

logException(e);

} finally {

try {

if(SDOConnectionWrapper != null) {

SDOConnectionWrapper.getConnection( ).close( );
SDOConnectionWrapper = null;

}

} catch (Throwable e1) {

logException(e1);

}
if(frequentFlyerInfoMediator != null) {

frequentFlyerInfoMediator.setConnectionWrapper(null);

}

}
return “”;

}
/**
* @paramBean id=frequentFlyerInfo
*/
public DataObject getFrequentFlyerInfoParameters( ) {

if(frequentFlyerInfoParameters == null) {

try {

frequentFlyerInfoParameters = getFrequentFlyerInfoMediator( )

.getParameterDataObject( );

} catch (MediatorException e) {

logException(e);

}

}
return frequentFlyerInfoParameters;

}
protected JDBCMediator getFrequentFlyerInfoMediator( ) {

if(frequentFlyerInfoMediator == null) {

try {

frequentFlyerInfoMediator = JDBCMediatorFactory.soleInstance

.createMediator(

getResourceInputStream

(frequentFlyerInfo_metadataFileName),

getSDOConnectionWrapper( ));

initSchema(getRealPath(frequentFlyerInfo_metadataFileName),

frequentFlyerInfoMediator.getSchema( ));

} catch (Throwable e) {

logException(e);

}

} else {

frequentFlyerInfoMediator

.setConnectionWrapper(getSDOConnectionWrapper( ));

}
return frequentFlyerInfoMediator;

}
/**
* @action id=frequentFlyerInfo
*/
public String doFrequentFlyerInfoFetchAction( ) {

try {

resolveParams(getFrequentFlyerInfoParameters( ),

frequentFlyerInfoArgNames, frequentFlyerInfoArgValues,
“frequentFlyerInfo_params_cache”);

DataObject graph = getFrequentFlyerInfoMediator( ).getGraph(

getFrequentFlyerInfoParameters( ));

frequentFlyerInfo = graph.getList(0);

} catch (Throwable e) {

logException(e);

} finally {

try {

if(SDOConnection Wrapper != null) {

SDOConnectionWrapper.getConnection( ).close( );
SDOConnection Wrapper = null;

}

} catch (Throwable e1) {

logException(e1);

}
if(frequentFlyerInfoMediator != null) {

frequentFlyerInfoMediator.setConnectionWrapper(null);

}

}
return “”;

}
/**
* @mediatorFactory com.ibm.etools.sdo.rdb.datahandlers.RelationalDataFactory
* @mediatorProperties metadataFileName=/WEB-INF/wdo/frequentFlyerInfo.xml
* @methodEntry id=frequentFlyerInfo/paramBean=frequentFlyerInfo/action=

frequentFlyerInfo

* @action FILL
*/
public List getFrequentFlyerInfo( ) {

if(frequentFlyerInfo == null) {

doFrequentFlyerInfoFetchAction( );

}
return frequentFlyerInfo;

}

After deployment, the annotations will be saved in files (in this example, in Java source code files (.java files)) which are managed by the IDE for continued use and further configurations/modifications.

In order for IDE vendors to make the code generation and packaging mechanism of the present invention available to different problem domains in addition to data access applications, IDE vendors may use a known extensibility mechanism in which vendors can apply the code generation and packaging mechanism of the present invention to different problem domains. For instance, through this extensibility mechanism, one vendor can contribute a set of annotations for capturing the necessary information to invoke a web service. As part of the contribution, the vendor may also contribute an annotation processor which will extract user input from the annotations to use in generating the code, for which they will also need to contribute a code generator.

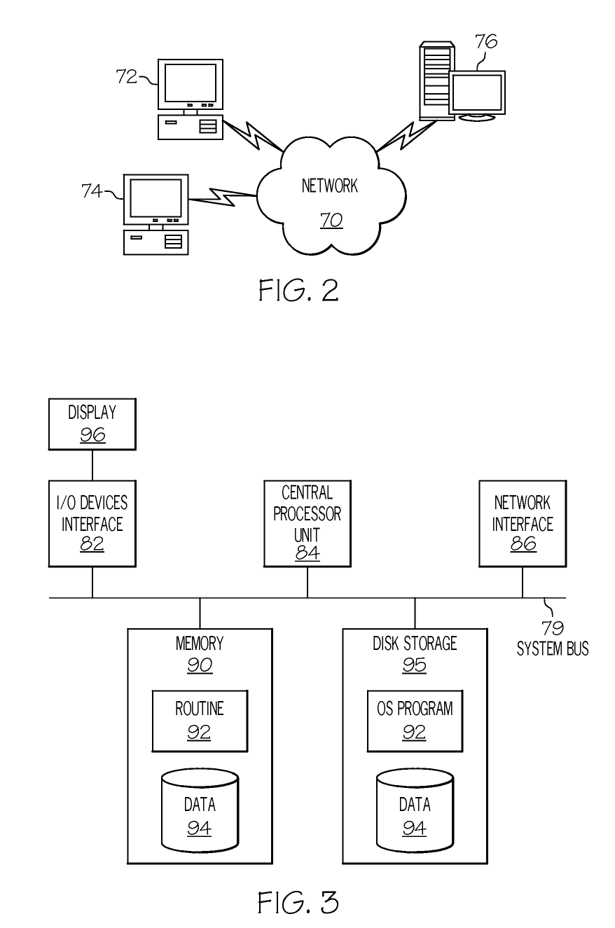

FIG. 2 is a schematic block diagram of a computer network in which embodiments of the present invention may operate. Computers 72, 74 and server 76 provide processing, storage, and input/output devices executing application programs and the like. Computer 72 may be linked through communications network 70 to other computing devices, including computer 74 and server 76. Communications network 70 can be part of the Internet, a worldwide collection of computers, networks, and gateways that currently use the TCP/IP suite of protocols to communicate with one another. The Internet provides a backbone of high-speed data communication lines between major nodes or host computers, consisting of thousands of commercial, government, educational, and other computer networks, that route data and messages. However, computers 72, 74 and server 76 may be linked over any suitable communication network. In the system of FIG. 2, computer 72 is running an IDE on which a computer program is being developed. The generated code can be for a desktop program or a server program. Thus, the generated code can be deployed to the computer running the IDE (computer 72), a separate computer 74, or server 76.

FIG. 3 is a diagram of the internal structure of a computer (e.g., computer 72 or server 76) in the computer network of FIG. 2. Each computer typically contains system bus 79, where a bus is a set of hardware lines used for data transfer among the components of a computer. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., display 96, printers, speakers, etc.) to the computer. Network interface 86 allows the computer to connect to various other devices attached to a network (e.g., network 70 of FIG. 2. Memory 90 provides volatile storage for computer software instructions used to implement an embodiment of the present invention. Disk storage 95 provides non-volatile storage for computer software instructions and data used to implement an embodiment of the present invention. Central processor unit 84 is also attached to system bus 79 and provides for the execution of computer instructions.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

“Computer” or “computing device” broadly refers to any kind of device which receives input data, processes that data through computer instructions in a program, and generates output data. Such computer can be a hand-held device, laptop or notebook computer, desktop computer, minicomputer, mainframe, server, cell phone, personal digital assistant, other device, or any combination thereof.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A method of developing software code, the method comprising:
soliciting and receiving user input regarding one or more software configuration properties;
storing the user input;
generating software code based on the user input; and
packaging the generated software code for deployment without allowing a user to edit the generated software code.

2. The method of claim 1, wherein the user input is stored as one or more annotations.

3. The method of claim 1, further comprising:
prior to generating the software code, creating and displaying a preview of the software code to be generated.

4. The method of claim 1, further comprising:
soliciting and receiving user selection of a software technology;
wherein generating software code comprises generating software code compliant with the selected software technology.

5. A system for developing software code, the system comprising:
a processing element configured for soliciting and receiving user input regarding one or more software configuration properties, storing the user input, generating software code based on the user input, and packaging the generated software code for deployment without allowing a user to edit the generated software code.

6. The system of claim 5, wherein the processing element stores the user input as one or more annotations.

7. The system of claim 5, wherein the processing element is further configured for, prior to generating the software code, creating a preview of the software code to be generated, and wherein the system further comprises a display element for displaying the preview of the software code.

8. The system of claim 5, wherein the processing element is further configured for soliciting and receiving user selection of a software technology, and wherein the processing element generates software code compliant with the selected software technology.

9. A computer program product for developing software code, the computer program product comprising at least one computer-readable storage medium having computer-readable program code stored therein, the computer-readable program code comprising:
computer-usable program code for soliciting and receiving user input regarding one or more software configuration properties;
computer-usable program code for storing the user input;
computer-usable program code for generating software code based on the user input; and
computer-usable program code for packaging the generated software code for deployment without allowing a user to edit the generated software code.

10. The computer program product of claim 9, wherein the user input is stored as one or more annotations.

11. The computer program product of claim 9, further comprising:
computer-usable program code for, prior to generating the software code, creating and displaying a preview of the software code to be generated.

12. The computer program product of claim 9, further comprising:
computer-usable program code for soliciting and receiving user selection of a software technology;
wherein the computer-usable program code for generating software code generates software code compliant with the selected software technology.
